(19) United States
(12) Patent Application Publication
(10) Pub. No.: US 2013/0115501 A1
(43) Pub. Date: May 9, 2013

(54) MOUNTING DEVICE FOR BATTERY

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/293,082

(22) Filed: Nov. 9, 2011

(30) Foreign Application Priority Data
Nov. 4, 2011 (CN) 201110344355.9

(51) Int. Cl. H01M 2/10

(52) U.S. Cl. 429/100; 429/96

(57) ABSTRACT

A mounting device for fixing a battery in place includes a board and a fixing member. Two tabs and two plates extend from the board to hold the battery. The fixing member forms a blocking piece on a top surface. A first end of the fixing member extends through one of the plates and then is latched with the blocking piece. A second end of the fixing member extends through the other plate and is formed into a loop to secure the fixing member over the battery.

### BACKGROUND

1. Technical Field

The present disclosure relates to a device for mounting a battery.

2. Description of Related Art

In an electronic device, such as a server, a redundant array of independent disk (RAID) cards is electrically connected to a battery, to protect cached data from being lost because of a power failure. However, the mounting of the battery to the chassis of the server with screws is less than optimal for a maintenance or replacement operation.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a mounting device together with a battery.

FIG. 2 is a partially assembled, isometric view of the mounting device and the battery of FIG. 1.

FIG. 3 is an assembled, isometric view of the mounting device and the battery of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

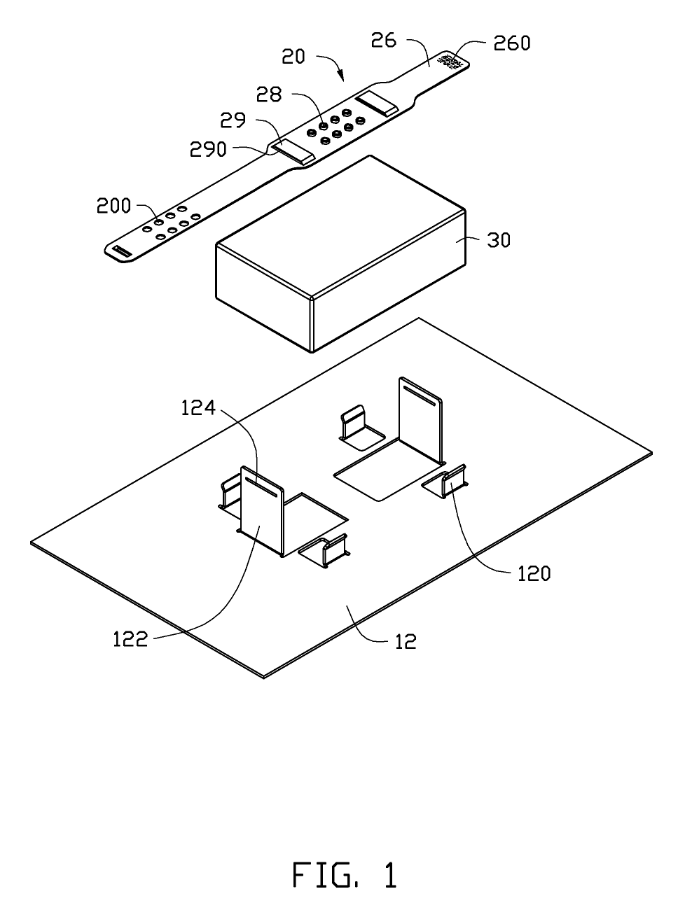

Referring to FIG. 1, an exemplary embodiment of a mounting device for mounting a battery 30 includes a base board 12 and a fixing member 20.

Two parallel rows of elastic tabs 120 perpendicularly extend up from the base board 12. The upper portions of the tabs 120 of each row slants outwards. A first and a second plate 122 perpendicularly extend up from the base board 12 at opposite ends of the rows of tabs 120. The first and second plates 122 are perpendicular to the tabs 120 and are between the rows of tabs 120. Each of the first and second plates 122 defines a slot 124 in an upper portion.

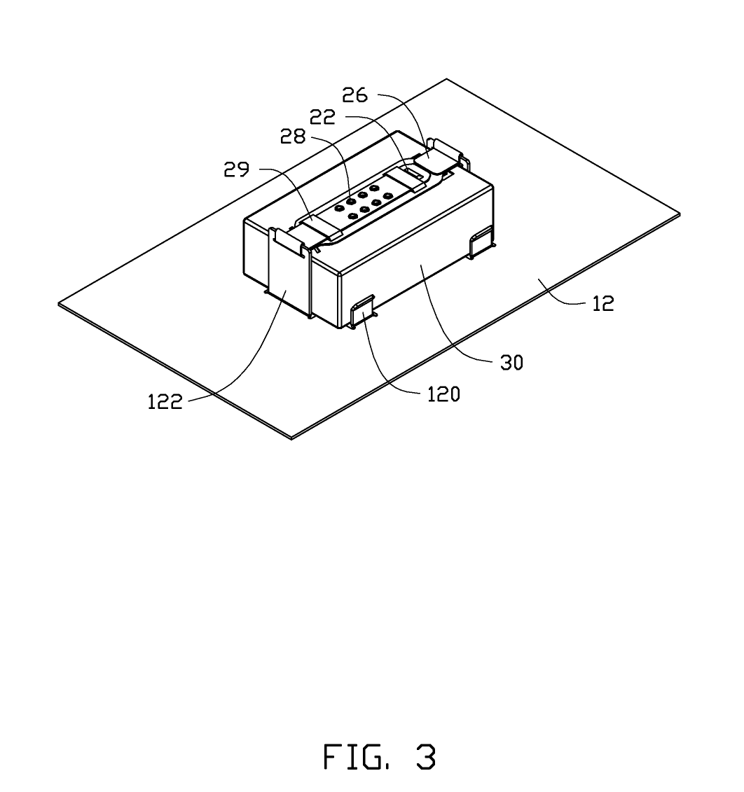

In one embodiment, the fixing member 20 is a strip of a polyester film, such as one sold under the trademark MYLAR. A wedge-shaped protrusion 22 (shown in FIG. 3) is formed on a first end of the bottom surface of the fixing member 20. The protrusion 22 is in the shape of a ramp and includes a blocking surface perpendicularly extending down from the bottom surface and facing the other end of the bottom surface, and a guiding surface slanting down towards the leading edge of the protrusion. A fixing portion 26 is formed on a second end of the fixing member 20. A plurality of projections 28 and two hollow bridge-shaped blocking pieces 29 (positioned at opposite ends of the projections 28) are formed around the centre of the top surface of the fixing member 20. The hollow portion of each blocking portion 29 is a through hole 290, down to the surface of the fixing member 20. A plurality of engaging holes 200 is defined in the fixing member 20 between the protrusion 22 and the nearer blocking piece 29.

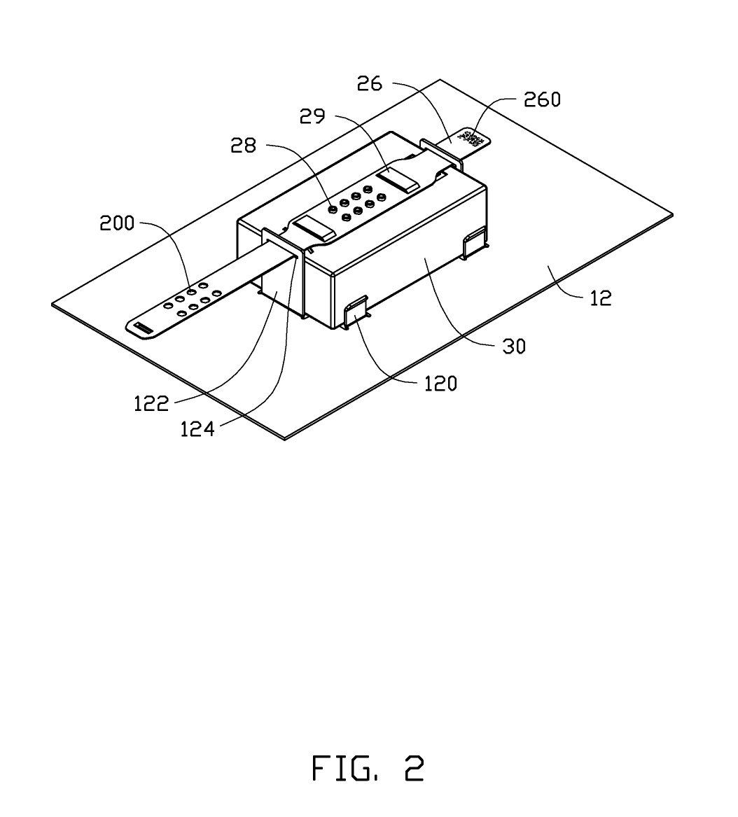

Referring to FIGS. 2 and 3, in assembly, the battery 30 is put on the base board 12 and is accommodated in the space among the tabs 120 and the first and second plates 122. The slanted upper portions of the tabs 120 guide the battery 30 down into the space bounded by the tabs 120 and the plates 122. The tabs 120 and the first and second plates 122 hold the battery 30 captive. The first end of the fixing member 20 is threaded out through the slot 124 of the first plate 122 and brought back over itself to extend through the through holes 290 and latch with the blocking piece 29 adjacent to the fixing portion 26, so the projections 28 may be pressed into engagement with the appropriate engaging holes 200. The second end of the fixing member 20 is threaded out through the slot 124 of the second plate 122 and brought back over itself to form a loop through the through hole 124. The loop may be made permanent by the use of glue 260 or other means. In this way, the battery 30 is held in place from every direction but may quickly and easily be removed and replaced.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a battery, comprising:
a base board to support the battery, the board forming two tabs to abut against opposite sides of the battery and two plates to abut against opposite ends of the battery; and
a fixing member to block a top of the battery, the fixing member forming at least one blocking piece on a top surface, a first end of the fixing member to extend through one of the plates and to be fixed to the at least one blocking piece; a second end of the fixing member opposite to the first end to extend through the other plate and to be fixed to the fixing member.

2. The mounting device of claim 1, wherein each plate defines a slot through which a corresponding one of the first end or second end of the fixing member extends.

3. The mounting device of claim 1, wherein the second end of the fixing member is to be glued to the fixing member.

4. The mounting device of claim 1, wherein a plurality of projections is formed around a center of the top surface of the fixing member, a plurality of engaging holes is defined in the fixing member between the first end of the fixing member and the projections, the projections are engaged in the engaging holes.

5. The mounting device of claim 4, wherein the number of the at least one blocking piece is two, the two blocking pieces are positioned at opposite ends of the projections.

6. The mounting device of claim 5, wherein each blocking piece is hollow and substantially bridge-shaped, the hollow portion of each blocking piece is a through hole; a protrusion protrudes from a bottom surface of the fixing member to extend through the through holes of the blocking pieces and is latched with the blocking piece adjacent to the second end of the fixing member.

7. The mounting device of claim 1, wherein the fixing member is made of a polyester film.

8. A battery assembly, comprising:
a battery;
a base board supporting the battery, the board forming two tabs to abut against opposite sides of the battery and two plates to abut against opposite ends of the battery; and
a fixing member blocking a top of the battery, the fixing member forming at least one blocking piece on a top surface, a first end of the fixing member extending through one of the plates and fixed to the at least one blocking piece; a second end of the fixing member opposite to the first end extending through the other plate and fixed to the fixing member.

9. The mounting device of claim 8, wherein each plate defines a slot through which a corresponding one of the first end or second end of the fixing member extends.

10. The mounting device of claim 8, wherein the second end of the fixing member is glued to the fixing member.

11. The mounting device of claim 8, wherein a plurality of projections is formed around a center of the top surface of the fixing member, a plurality of engaging holes is defined in the fixing member between the first end of the fixing member and the projections, the projections are engaged in the engaging holes.

12. The mounting device of claim 11, wherein the number of the at least one blocking piece is two, the two blocking pieces are positioned at opposite ends of the projections.

13. The mounting device of claim 12, wherein each blocking piece is hollow and substantially bridge-shaped, the hollow portion of each blocking piece is a through hole; a protrusion protrudes from a bottom surface of the fixing member to extend through the through holes of the blocking pieces and is latched with the blocking piece adjacent to the second end of the fixing member.

14. The mounting device of claim 8, wherein the fixing member is made of a polyester film.
